(19) United States
(12) Patent Application Publication
(10) Pub. No.: US 2026/0164289 A1
(43) Pub. Date: Jun. 11, 2026

(54) INTEGRATION OF CARRIER NETWORK DRIVEN AND UE DRIVEN ENHANCED SERVICES

(71) Applicant: AT&T Intellectual Property I, L.P., Atlanta, GA (US)

(72) Inventors: Yupeng Jia, South Pasadena, CA (US); Rashmi Palamadai, Naperville, IL (US)

(73) Assignee: AT&T Intellectual Property I, L.P., Atlanta, GA (US)

(21) Appl. No.: 18/969,682

(22) Filed: Dec. 5, 2024

(51) Int. Cl. H04W 28/02; H04W 64/00

(52) U.S. Cl. CPC H04W 28/0226; H04W 28/0289; H04W 64/003

(57) ABSTRACT

Aspects of the subject disclosure may include, for example, a device that analyzes network conditions to identify congested areas and detects user equipment heading there. It may predict arrival time, offer an upgrade to enhanced services, receive a request, and grant the services. The device may facilitate device-to-device communication, manage handoffs between networks, and uses AI to calculate user movement probabilities. Enhanced services may be provided, including increased bandwidth allocation. Other embodiments are disclosed.

### FIELD OF THE DISCLOSURE

The subject disclosure relates to the Integration of Carrier Network Driven and UE Driven Enhanced Services.

### BACKGROUND

Mobile device users may experience degraded service when they find themselves in locations of network congestion such as festivals, concerts, or other events where congestion is common. Current solutions often fail to provide adequate connectivity in these high-demand areas, leading to degraded service quality and user dissatisfaction.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for Integration of Carrier Network Driven and UE Driven Enhanced Services. Other embodiments are described in the subject disclosure.

Various embodiments described herein provide for the integration of carrier network-driven and user equipment (UE)-driven enhanced services to improve network performance and user experience by providing targeted services to customers in specific locations, particularly in areas of known network congestion. This provides a real-time, UE-application-driven intelligent approach that allows the carrier to assign and provide appropriate network resources at a given time and location for specific purposes. The assignment of appropriate network resources may be triggered by actual application usage, prompting real-time traffic management and targeted marketing for upsell opportunities.

Various embodiments described herein address the problem of network congestion in high-demand areas, such as festivals or concerts, where users often experience degraded service quality. By predicting user behavior and network conditions, the carrier can proactively offer enhanced services to users heading into these congested areas. The system includes features such as device-to-device communication, where user devices can communicate with neighboring devices to recommend enhanced services based on performance. Additionally, the invention supports private and public network handoffs, eCommerce and incentive-based handoffs, and UE-driven immersive experiences that allow users to share real-time experiences with others outside the location.

Various use cases include scenarios where the carrier pushes targeted value-added services to users heading to known network congestion areas. For example, users attending a public event may receive pre-sell or pop-up notifications for service upgrades, allowing them to make informed purchase decisions in advance. Various embodiments also support temporary elevated services for select customers based on their history and loyalty, ensuring that enhanced functions are not oversold and that users have a guaranteed experience. AI-based analysis may help calculate the probability of users leaving and returning to a venue, optimizing network capacity and resource allocation.

Various benefits may include improved network use, real-time traffic management, targeted marketing, and improved planning based on real-time data. User experience may be enhanced by providing extra resources during busy times and facilitating better performance through device-to-device communication. Further features may include network-driven optimization of sound quality, integration with third-party applications for immersive experiences, and further refinement of user-driven, application-driven, and network-driven capabilities.

One or more aspects of the subject disclosure include a device includes a processing system with a processor and a memory that stores executable instructions. When these instructions are executed by the processing system, they perform several operations, including analyzing network conditions to determine the available capacity and bandwidth at a specific location, and determining if this location is a congested network area. The device detects if a user equipment (UE) is heading towards this congested location and predicts the arrival time of the UE. It offers an upgrade to enhanced network services to the UE at the congested location, receives a request for these enhanced services from the UE, and grants the enhanced network services for use at the congested location.

In some embodiments, the detection that the UE is heading to the congested location is based on GPS data. Alternatively, or in addition, in some embodiments, the detection can be based on network activity. Further, in some embodiments, the offer to upgrade to enhanced network services can be made in advance of the UE's arrival at the congested location or upon the UE's arrival, and the granting of enhanced network services may occur upon the UE's arrival at the congested location.

In some embodiments, the operations further include facilitating device-to-device communication between the UE and neighboring devices to recommend enhanced network services based on the performance of similar capability devices. The device may also manage handoffs between private and public networks to provide additional levels of service based on network capacity. Artificial intelligence may be utilized to calculate the probability of users leaving and returning to the congested network location, and in some embodiments, the enhanced network services may include increased bandwidth allocation.

One or more aspects of the subject disclosure include a non-transitory machine-readable medium contains executable instructions that, when executed by a processing system with a processor, perform several operations. The operations may include determining that a location of a scheduled event will be a congested network location, detecting that a UE is heading to this location, offering an upgrade to enhanced network services to the UE at the congested location, receiving a request for these enhanced services from the UE, and granting the enhanced network services for use at the congested location.

In some embodiments, the operations may also include facilitating device-to-device communication between the UE and neighboring devices to recommend enhanced network services to the neighboring devices, and managing a handoff to a private network serving the congested location to provide the enhanced network services. In some embodiments, artificial intelligence is used to calculate the probability of users leaving and returning to the congested network location. Further, in some embodiments, the enhanced network services may include increased bandwidth allocation.

One or more aspects of the subject disclosure include a method that includes receiving a request for access to enhanced network services from a UE by a processing system with a processor. The processing system determines that the UE is located in a congested network location and manages a handoff to a private network serving the congested location to provide the enhanced network services. The method may further includes determining that the congested network location is served by the private network. The request for access to the enhanced network services may include receiving a communication indicating the type of activity being performed by the UE or the type of enhanced services being requested, and the method may also include determining the probability of users leaving and returning to the congested network location.

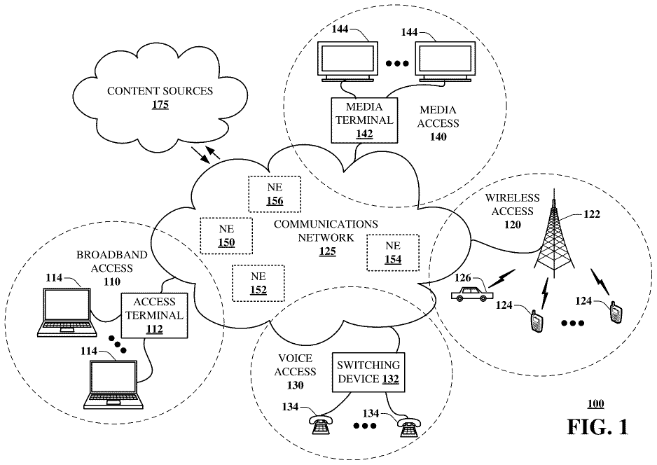

Referring now to FIG. 1, a block diagram is shown illustrating an example, non-limiting embodiment of a system 100 in accordance with various aspects described herein. For example, system 100 can facilitate in whole or in part Integration of Carrier Network Driven and UE Driven Enhanced Services. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

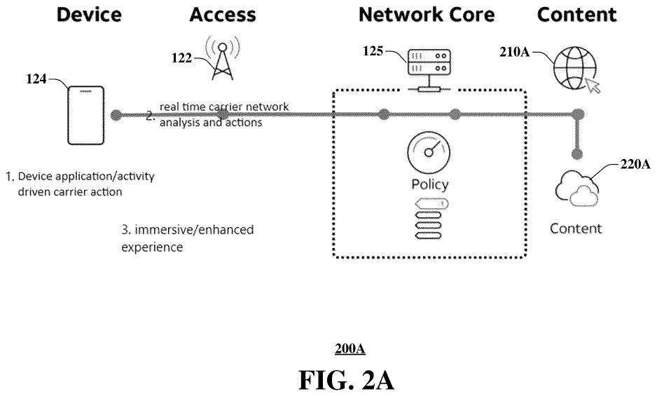

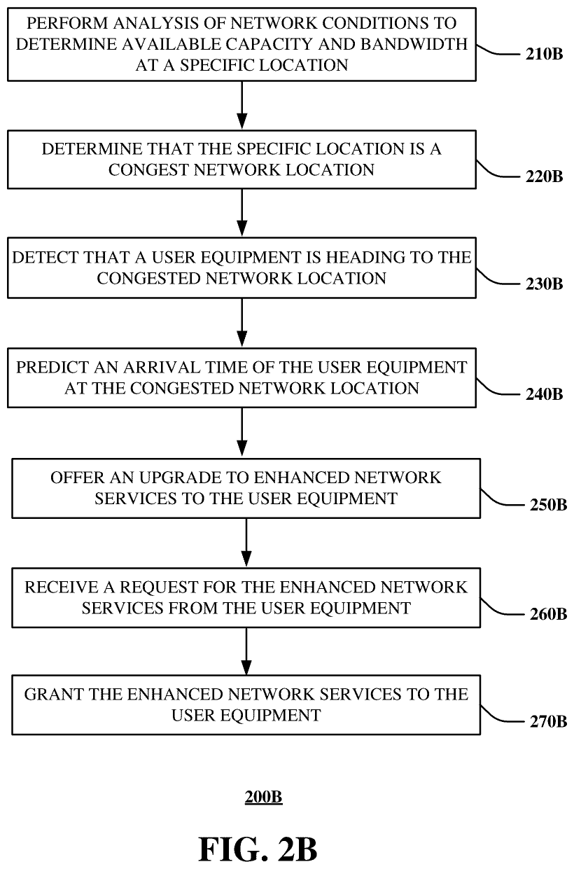

FIG. 2A is a block diagram illustrating an example, non-limiting embodiment of a system functioning within the communication network of FIG. 1 in accordance with various aspects described herein.

The access point 122 is a component within the communications network 125, facilitating wireless access 120 to a plurality of mobile devices (also referred to herein as “user equipment”) 124. The access point 122 can include a 4G, 5G, or higher generation base station, or an access point that operates via an 802.11 standard such as 802.11n, 802.11ac, or other wireless access terminal. The access point 122 enables the connection of user equipment 124 to the communications network 125, allowing for the transmission and reception of data. The access point 122 plays a role in managing network traffic and ensuring that adequate capacity and bandwidth are available for users, particularly in congested network locations.

The user equipment 124 refers to mobile devices such as smartphones, tablets, e-readers, phablets, and wireless modems that connect to the communications network 125 via the access point 122 (or via some other connection method or means). In some embodiments, the user equipment 124 is capable of detecting network conditions and can trigger real-time traffic management based on actual application usage. For instance, when a user attempts to live stream a video and experiences slow uplink speeds, the user equipment 124 can prompt the network to offer an upgrade to enhanced network services. The user equipment 124 can also engage in device-to-device communication with neighboring devices to recommend enhanced services based on performance measures of similar capability devices.

The communications network 125 is a comprehensive system that provides broadband access 110, wireless access 120, voice access 130, and media access 140 to various devices. The network includes a plurality of network elements 150, 152, 154, 156, etc., which facilitate the distribution of content from content sources 175. The communications network 125 can include circuit-switched or packet-switched networks, VoIP networks, IP networks, cable networks, optical networks, and various wireless access networks such as 4G, 5G, WIMAX, and UltraWideband networks. In some embodiments, one or more network elements within network 125 continuously performs analysis of network conditions to determine available capacity and bandwidth at specific locations, particularly in congested network areas. The network detects when user equipment 124 is heading towards these locations and predicts the arrival time, offering upgrades to enhanced network services accordingly.

The Internet 210A serves as a global network that interconnects various local and wide area networks, enabling the exchange of data and communication between devices connected to the communications network 125. The Internet 210A provides access to a vast array of content and services, including web servers, data servers, and streaming platforms. The combination of the Internet 210A with the communications network 125 allows for seamless access to online resources and supports the delivery of enhanced network services to user equipment 124.

Content 220A refers to the various types of media and data that are transmitted over the communications network 125 and accessed by user equipment 124. This includes audio, video, graphics, text, and other forms of digital content. Content 220A can originate from content sources 175 and be delivered to user equipment 124 via the Internet 210A. The availability and quality of content 220A are influenced by the network's capacity and bandwidth, which are managed in real-time to ensure optimal user experience, especially in congested network locations.

In operation, one or more network elements perform analysis of network conditions to determine available capacity and bandwidth at specific locations, determine that a specific location is a congested network location, detect that user equipment 124 is heading to the congested network location, predicts an arrival time of the user equipment 124 at the congested network location, offers an upgrade to enhanced network services to the user equipment 124 at the congested network location, receives a request for the enhanced network services from the user equipment 124, and grants the enhanced network services to the user equipment 124 for use at the congested network location.

In some embodiments, the detection that the user equipment 124 is heading to the congested network location can be based on GPS data or network activity. The offer to upgrade to enhanced network services can be made in advance of the user equipment's arrival at the congested network location or upon the user equipment's arrival. The granting of enhanced network services may occur upon the user equipment's arrival at the congested network location.

The system also facilitates device-to-device communication between the user equipment 124 and neighboring devices to recommend enhanced network services based on the performance of similar capability devices. The system manages handoffs between private and public networks to provide additional levels of service based on network capacity. Artificial intelligence is utilized to calculate the probability of users leaving and returning to the congested network location, and the enhanced network services may include increased bandwidth allocation.

In some embodiments, the system allows the carrier to assign and provide appropriate network resources at a given time and location for specific purposes based on real-time application usage, triggering real-time traffic management and targeted marketing for upsell opportunities. Concurrent real-time analysis on the network ensures adequate capacity and bandwidth are available for users, including targeted marketing for upsell eCommerce services to ensure adequate network resources for each user. The system also analyzes users who have arrived or left a location in real-time to allow for additional targeted upsell opportunities.

In crowded venues, user devices can communicate with neighboring devices to determine performance. If one device is on an enhanced service, the carrier can recommend the same enhanced service to other devices via pop-up notifications. The system manages handoffs between private and public networks as needed, depending on network capacity at a location, including eCommerce and incentive-based handoffs. It supports UE-driven immersive experiences, allowing users to share real-time experiences with others outside the location and capture these experiences for a ‘memory box’ to be shared with specific users afterward. The carrier provides boosted network resources for this purpose.

Enhanced network services can be provided by either the public network or a private network, depending on the availability of resources and the specific requirements of the user equipment (UE). The public network, typically accessible to the general public, may experience high levels of traffic and congestion, but it still may be able to offer enhanced services through dynamic resource allocation and real-time traffic management. On the other hand, private networks, dedicated to specific organizations or entities, may have more available resources and may be able to provide a higher level of control, security, and performance.

For example, consider a scenario where a user attends a large public event such as a music festival. The public network in the area may become congested due to the high number of attendees using their devices simultaneously. To address this, the public network may offer enhanced network services to the user. Upon detecting that the user is heading to the event location, the network can send a pop-up notification offering an upgrade to a higher tier of service. This upgrade ensures better connectivity and faster data speeds, allowing the user to make phone calls, send messages, and access the internet without experiencing the typical slowdowns associated with network congestion.

In another example, an influencer at the same music festival may wish to live stream the event. As the user initiates the live stream, the public network may detect slow uplink speeds due to congestion. The network may then automatically offer an upgrade to enhanced services, ensuring that the live stream is broadcast smoothly without interruptions. This provides a high-quality viewing experience for the audience and allows the influencer to maintain their online presence effectively.

Private networks are typically dedicated communication networks that are owned and operated by a specific organization or entity, providing exclusive access to network resources for its users. For example, a private network may be Unlike public networks, which are accessible to the general public and often experience high levels of traffic and congestion, in some embodiments, private networks may be able to offer a higher level of control, security, and performance. Because private networks are not subject to the same level of demand as public networks, they often have more available network resources, such as bandwidth and capacity, to allocate to their users. This can result in a more reliable and higher quality of service, particularly in environments where network performance is critical. For instance, in a congested public network scenario, a private network can provide enhanced services by leveraging its dedicated resources to ensure that users experience minimal latency, higher data transfer rates, and more stable connections.

In some embodiments, a network element within the communications network (e.g., NE 150, 152, 154, 156) may make the decision to hand off a user equipment (UE) to a private network to provide enhanced network services based on several factors. For example, the network element may continuously monitor network conditions, including available capacity, bandwidth, and current traffic load at specific locations. When the network element detects that a particular location is experiencing congestion or is likely to become congested, it evaluates the performance metrics of both the public and private networks available in that area.

The decision-making process may involve analyzing the quality of service (QoS) requirements of the UE, such as the need for higher data transfer rates, lower latency, or more stable connections. If the public network is unable to meet these QoS requirements due to high demand or limited resources, the network element may assess the private network's capacity to provide the necessary enhanced services. This assessment may include checking the private network's available bandwidth, current load, and overall performance.

Once the network element determines that the private network can offer a superior level of service, it may initiate a handoff process. This involves coordinating with the private network to ensure a seamless transition, maintaining the UE's ongoing sessions, and minimizing any potential disruption to the user's experience. The network element may also communicate with the UE to inform it of the impending handoff and provide any necessary instructions or updates.

When a user attends a large public event like a music festival, sports event, or concert, the network in the area often becomes congested due to the high number of attendees using their devices simultaneously. Enhanced network services can be offered to the user in advance or upon arrival at the event. For example, the carrier can send a pop-up notification offering an upgrade to a higher tier of service that ensures better connectivity and faster data speeds. This allows the user to make phone calls, send messages, and access the internet without experiencing the typical slowdowns associated with network congestion.

Influencers or users who wish to live stream an event, such as a concert or a significant personal moment, can benefit from enhanced network services. When the user initiates a live stream and the uplink speed is found to be slow due to congestion, the network can automatically offer an upgrade to enhanced services. This ensures that the live stream is broadcast smoothly without interruptions, providing a high-quality viewing experience for the audience.

Enhanced network services are particularly beneficial for users engaging in virtual reality (VR) or augmented reality (AR) applications. For example, a family visiting a theme park like Disney World may want to share their experience in real-time with relatives who cannot be physically present. The UE can detect the use of a VR/AR application and prompt the network to offer an upgrade to enhanced services. This upgrade ensures that the immersive experience is seamless, with minimal latency and high data transfer rates, allowing the family to share their adventure in real-time with their loved ones.

In crowded venues, user devices can communicate with neighboring devices to determine performance. If one device is on an enhanced service, it can recommend the same enhanced service to other devices via pop-up notifications. This ensures that users in the vicinity can also benefit from improved connectivity and performance.

Users who frequently visit areas of known network congestion, such as busy city centers or popular tourist attractions, can benefit from proactive updates and trials of enhanced services. The carrier can analyze the user's behavior and offer tiered services or discounted free trials based on their history and loyalty. This allows users to experience the benefits of enhanced services without committing to a long-term upgrade, improving their overall satisfaction and encouraging future use.

FIG. 2B depicts an illustrative embodiment of a method in accordance with various aspects described herein. At block 210B of method 200B, the method involves performing an analysis of network conditions to determine available capacity and bandwidth at a specific location. In some embodiments, this analysis is conducted by network elements within the communications network 125. For example, the network elements may continuously monitor traffic loads and resource availability to assess the current state of the network.

At block 220B, the method determines that the specific location is a congested network location. In some embodiments, this determination is based on the analysis performed in block 210B. For example, if the network elements detect high traffic volumes and limited available bandwidth, they may classify the location as congested.

At block 230B, the method detects that a user equipment is heading to the congested network location. In some embodiments, this detection is based on GPS data or network activity. For example, the network elements may track the movement of user equipment 124 and predict its trajectory towards the congested area.

At block 240B, the method predicts an arrival time of the user equipment at the congested network location. In some embodiments, this prediction is made using the detected movement patterns and speed of the user equipment. For example, the network elements may use algorithms to estimate when the user equipment will reach the congested location.

At block 250B, the method offers an upgrade to enhanced network services to the user equipment. In some embodiments, this offer is made via a pop-up notification or message sent to the user equipment. For example, the network may propose an upgrade to a higher tier of service to ensure better connectivity and performance.

At block 260B, the method receives a request for the enhanced network services from the user equipment. In some embodiments, the user equipment responds to the offer by sending a request back to the network. For example, the user may accept the upgrade through an interface on their device.

At block 270B, the method grants the enhanced network services to the user equipment. In some embodiments, this involves allocating additional network resources to the user equipment. For example, the network may increase the bandwidth and prioritize the traffic of the user equipment to provide an improved service experience.

In some embodiments, method 200B facilitates device-to-device communication between the user equipment and neighboring devices to recommend the enhanced network services based on a performance measure of similar capability device. For example, various embodiments may enable user equipment 124 to communicate with neighboring devices to determine performance. If one device is on an enhanced service, the device can recommend the same enhanced service to other devices via pop-up notifications. This ensures that users in the vicinity can also benefit from improved connectivity and performance. One or more network elements within the communications network 125 may manage this device-to-device communication, ensuring that recommendations are based on accurate performance measures.

In some embodiments, method 200B facilitates managing a handoff between private and public networks to provide additional levels of service based on network capacity. For example, various embodiments may coordinate the transition of user equipment 124 from a public network to a private network so that the private network may provide enhanced network services. This handoff may be managed by one or more of the network elements within the communications network 125, which continuously monitor network conditions, including available capacity, bandwidth, and current traffic load at specific locations. When the network element(s) detect that a particular location is experiencing congestion or is likely to become congested, they evaluate the performance metrics of both the public and private networks available in that area. The decision to hand off a user equipment 124 to a private network may be based on the ability of the private network to provide the necessary enhanced services.

In some embodiments, method 200B facilitates utilizing artificial intelligence to calculate a probability of users leaving and returning to the congested network location. For example, various embodiments may employ AI algorithms to predict user behavior. One or more of the network elements within the communications network 125 may use AI to calculate the probability of users leaving and returning to the congested network location. This prediction helps in optimizing network capacity and resource allocation, ensuring that enhanced network services are provided efficiently. The AI-based analysis allows the network to make informed decisions about resource allocation and service provisioning.

In some embodiments, the congested network determination may include a prediction such as determining that the particular area will be congested at a particular time and/or for a particular amount of time. For example, if the projected congestion is above a first threshold, and the projected congestion is expected to last longer than a second threshold, then the particular area may be considered a congested network location.

In some embodiments, the amount or type of a service upgrade may be influenced by a prediction of how severe congestion is expected to be and/or how long the congestion is expected to last. For example, if a network location is expected to experience congestion beyond a certain time period or during a certain time period (e.g., after 8 am or between 8 am and 5 pm), then the amount of resources allocated during the service period may be increased or decreased.

In some embodiments, the measured congestion or predicted congestion may be classified at different levels and for different services, and the upgrade may be adjusted accordingly? For example, a relatively low level of upgraded service may be offered in response to a low level of congestion, and a relatively high level of upgraded service may be offered in response to a high level of congestion.

In some embodiments, providing the upgrade may improve performance for the network as a whole (or for all devices in a particular area served by the network). For example, in some embodiments, an upgraded service provided to a first device may render a better quality of service for a second device that has not received the upgrade but has other resources made available to it due to the service upgrade to the first device (which no longer needs the original resources because it is now using other resources due to the upgrade).

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

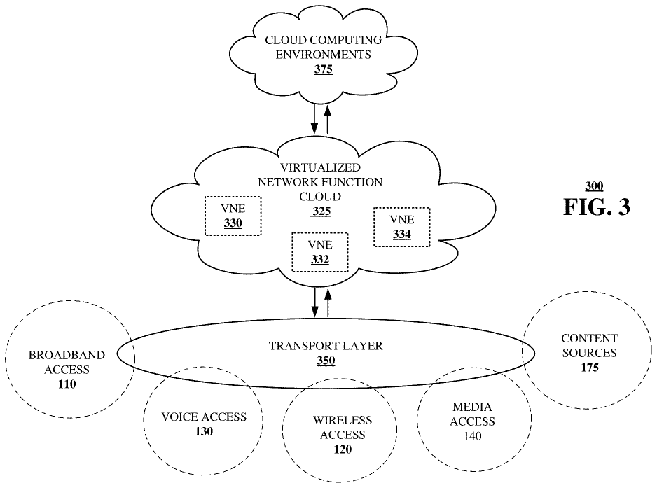

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems and functions described herein. For example, virtualized communication network 300 can facilitate in whole or in part Integration of Carrier Network Driven and UE Driven Enhanced Services.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

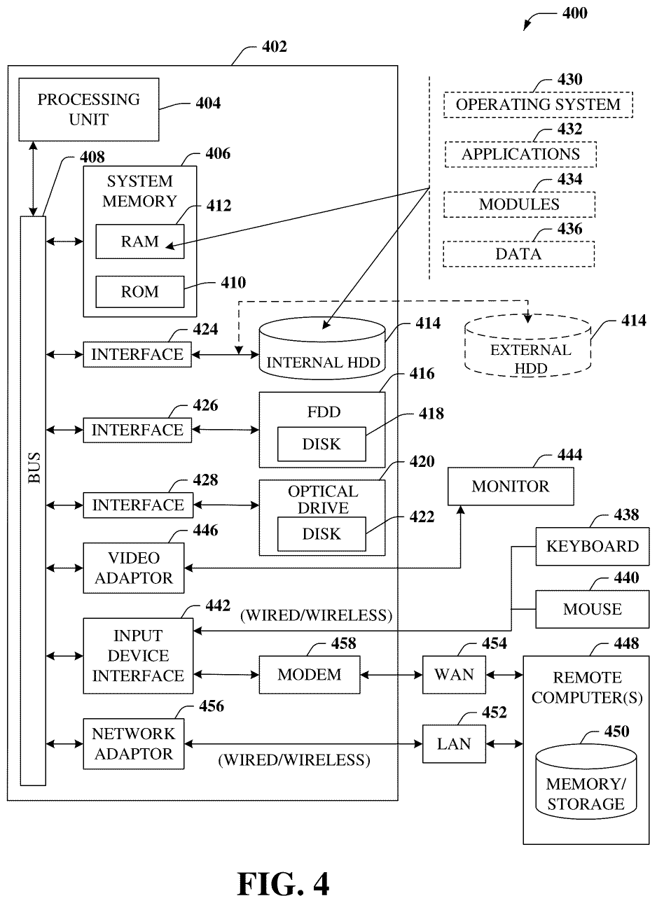

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part Integration of Carrier Network Driven and UE Driven Enhanced Services.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

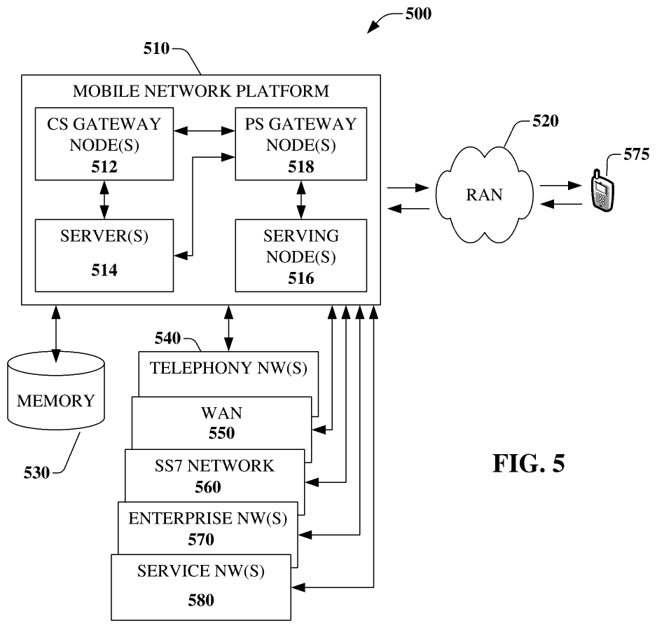

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part Integration of Carrier Network Driven and UE Driven Enhanced Services. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

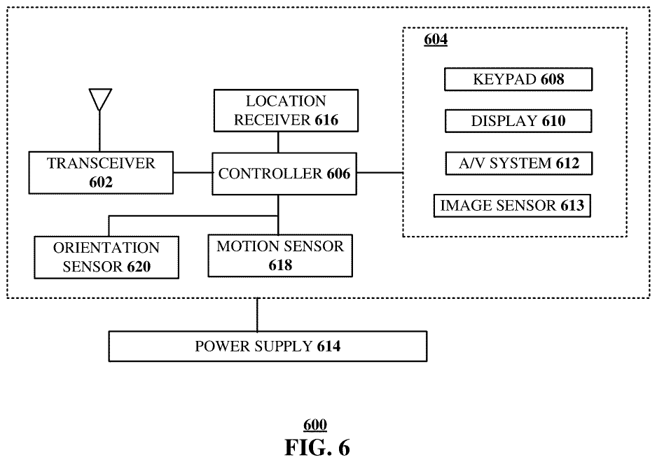

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part Integration of Carrier Network Driven and UE Driven Enhanced Services.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner that can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
performing analysis of network conditions to determine available capacity and bandwidth at a specific location;
determining that the specific location is a congested network location;
detecting that a user equipment is heading to the congested network location;
predicting an arrival time of the user equipment at the congested network location;
offering an upgrade to enhanced network services to the user equipment at the congested network location;
receiving a request for the enhanced network services from the user equipment; and
granting the enhanced network services to the user equipment for use at the congested network location.

2. The device of claim 1, wherein the detecting that the user equipment is heading to the congested network location is based on GPS data.

3. The device of claim 1, wherein the detecting that the user equipment is heading to the congested network location is based on network activity.

4. The device of claim 1, wherein the offering the upgrade to the enhanced network services to the user equipment is in advance of arrival of the user equipment at the congested network location.

5. The device of claim 1, wherein the offering the upgrade to the enhanced network services to the user equipment is upon of arrival of the user equipment at the congested network location.

6. The device of claim 1, wherein the granting the enhanced network services to the user equipment is upon arrival at the congested network location.

7. The device of claim 1, wherein the operations further comprise facilitating device-to-device communication between the user equipment and neighboring devices to recommend the enhanced network services based on a performance measure of similar capability devices.

8. The device of claim 1, wherein the operations further comprise managing handoff between private and public networks to provide additional levels of service based on network capacity.

9. The device of claim 1, wherein the operations further comprise utilizing artificial intelligence to calculate a probability of users leaving and returning to the congested network location.

10. The device of claim 1, wherein the enhanced network services include increased bandwidth allocation.

11. A non-transitory machine-readable medium, comprising executable instructions that, when executed by a processing system including a processor, facilitate performance of operations, the operations comprising:
determining that a location of a scheduled event will be a congested network location;
detecting that a user equipment is heading to the congested network location;
offering an upgrade to enhanced network services to the user equipment at the congested network location;
receiving a request for the enhanced network services from the user equipment; and
granting the enhanced network services to the user equipment for use at the congested network location.

12. The non-transitory machine-readable medium of claim 11, wherein the operations further comprise facilitating device-to-device communication between the user equipment and neighboring devices to recommend the enhanced network services to the neighboring devices.

13. The non-transitory machine-readable medium of claim 11, wherein the operations further comprise managing a handoff to a private network serving the congested network location to provide the enhanced network services.

14. The non-transitory machine-readable medium of claim 11, wherein the operations further comprise calculating, utilizing artificial intelligence, a probability of users leaving and returning to the congested network location.

15. The non-transitory machine-readable medium of claim 11, wherein the enhanced network services include increased bandwidth allocation.

16. A method, comprising:
receiving from a user equipment, by a processing system including a processor, a request for access to enhanced network services;
determining, by the processing system, that the user equipment is located in a congested network location; and
managing a handoff to a private network serving the congested network location to provide the enhanced network services.

17. The method of claim 16, further comprising:
determining, by the processing system, that the congested network location is served by the private network.

18. The method of claim 16, wherein the receiving the request for access to the enhanced network services comprises receiving a communication indicating a type of activity being performed by the user equipment.

19. The method of claim 16, wherein the receiving the request for access to the enhanced network services comprises receiving a communication indicating a type of enhanced services being requested by the user equipment.

20. The method of claim 16, further comprising:
determining, by the processing system, a probability of users leaving and returning to the congested network location.
